(19) United States
(12) Patent Application Publication
(10) Pub. No.: US 2012/0126661 A1
(43) Pub. Date: May 24, 2012

(54) Replaceable Ground Ring For Slip Ring Assembly

(75) Inventors: David S. Ketner, Greenville, SC (US); John R. Jasek, Greenville, SC (US)

(73) Assignee: MORGAN AM&T, Greenville, SC (US)

(21) Appl. No.: 12/949,036

(22) Filed: Nov. 18, 2010

(51) Int. Cl. H01R 39/08; B23P 6/00

(52) U.S. Cl. 310/228; 29/402.08

(57) ABSTRACT

The present invention relates to slip ring assemblies with separately replaceable ground rings. Also provided are separately replaceable ground rings and methods of replacing such rings in slip ring assemblies, as well as kits for performing the same. The rings, assemblies, methods, and kits of the present invention are particularly useful in wind turbines and other applications where accessibility poses significant obstacles to maintenance operations.

### BACKGROUND OF THE INVENTION

The present invention relates to slip ring assemblies and components thereof used in power generation and transfer, as well as, methods of replacing a ground ring in such assemblies. The rings, assemblies, and methods of the present invention are particularly useful in wind turbines and other applications where accessibility poses significant obstacles to maintenance operations.

Slip ring assemblies are commonly used in the power generation industry. One or more power rings, and typically three power rings (for three phase power generation), are employed as part of a fixed assembly that also integrally includes a ground ring. The ground ring serves to ground flux or stray current induced during power generation. The ground ring is usually the component that deteriorates most rapidly, which can be due, in part, to electrical erosion that causes pitting. Because the ground ring is an integral part of existing slip ring assemblies, the entire assembly, including the power rings, the ground ring, and the hub to which they are affixed, must be replaced, even though it is just the ground ring that has worn out. Because conventional slip ring assemblies are integrally molded together, and often shrink-fit together, attempting to remove the ground ring from an existing slip ring assembly is impractical, if not impossible, and, if attempted, generally causes damage to the slip ring assembly. This situation causes significant waste in material and time as the entire assembly has to be hoisted down from the heights of a wind turbine and then an entire replacement assembly hoisted back up. Operators and maintenance crews can be put at unnecessary risk in these replacement exercises.

Accordingly, there exists a need for less costly, less wasteful, and less dangerous slip ring replacements. This need is particularly acute in the green power industry.

### SUMMARY OF THE PRESENT INVENTION

A feature of the present invention is to provide a slip ring assembly that permits the easy replacement of the ground ring.

A further feature of the present invention is to provide a slip ring assembly that avoids the need to replace other components of the slip ring assembly when the only component that needs replacing is the ground ring.

An additional feature of the present invention is to provide a slip ring assembly and a method of replacing a ground ring, which avoids the need to disassemble the entire slip ring assembly in order to replace the ground ring and/or avoids the need to totally replace the entire slip ring assembly and/or avoids the need to remove the slip ring assembly in order to replace the ground ring.

A further feature of the present invention is to provide a slip ring assembly that overcomes one or more of the disadvantages indicated herein with respect to conventional slip ring assemblies.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a slip ring assembly. The slip ring assembly can include at least one power ring affixed to a hub and at least one ground ring mounted on the hub, wherein the ground ring is separately replaceable, while the slip ring assembly is in cooperation with an armature, and without having to replace the power ring or hub or both.

The present invention also relates to a separately replaceable ground ring alone or in combination with the slip ring assembly. The ground ring can include a conductive annular body; an outer perimeter of the annular body; an inner perimeter of the annular body defining a central aperture; and at least one interface surface, disposed on the annular body, between the outer and inner perimeters, to allow for operable connection to at least one interface surface of a slip ring assembly; wherein the annular body is configured for replaceable attachment to the slip ring assembly.

The ground ring can include a central aperture centered with respect to an axis of rotation; a perimeter surface having a first end, a second end, and a circular cross-section from the first end to the second end; an outer surface having an outer periphery and an inner periphery arranged perpendicularly to the axis of rotation; and an inner surface having a first end and a second end, wherein the first end on the inner surface and the inner periphery intersect at a first inner edge, the second end of the perimeter surface and the outer periphery intersect at a first outer edge, the inner surface tapers outwardly from its first end toward its second end, and one or more mounting apertures are formed in the inner surface and outer surface extending through the ground ring in a direction parallel to the axis of rotation for mounting the ground ring to the slip ring assembly.

The present invention also provides a method of replacing a worn or damaged ground ring of a slip ring assembly. The method can include removing an existing ground ring from a slip ring assembly comprising a hub, at least one ground ring, and at least one power ring; and attaching a replacement ground ring to the slip ring assembly.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF DRAWINGS

FIG. 1 is a front/side perspective view of a slip ring assembly of the present invention with the ground ring in a detached position.

FIG. 2 is a front/side perspective view of a slip ring assembly as shown in FIG. 1, with the ground ring in contact with the hub of the slip ring assembly.

FIG. 3 is a front/left side perspective view of a slip ring assembly similar to that shown in FIG. 1, with the ground ring detached.

FIG. 4 is an inner side perspective view of a ground ring.

FIG. 5 is an outer side perspective view of a ground ring.

FIG. 6 is a side cross-sectional view of a ground ring.

FIG. 7 is a front inner side cross-sectional view of a ground ring.

### DETAILED DESCRIPTION OF THE PRESENT INVENTION

The present invention relates to a slip ring assembly. The slip ring assembly can include at least one power ring affixed to a hub and at least one ground ring mounted on the hub, wherein the ground ring is separately replaceable, while the slip ring assembly is in cooperation with an armature, and without having to replace the power ring or hub or both. The at least one power ring and hub of the slip ring assembly can constitute a molded sub-assembly. The molded sub-assembly can be shrink-fit. The ground ring can be mounted on or otherwise connected to the molded sub-assembly, but need not be part of the sub-assembly. The slip ring assembly, and the sub-assembly, can include one or more power (slip) rings. Three rings can be provided for three-phase power generation. The slip ring assembly can include at least one brush in electromechanical association with the at least one power ring. One or more power rings are insulated from the hub using any suitable insulating material. Examples of suitable insulators include a plastic, a rubber, a composite, a glass, a ceramic, or any combination thereof.

The present invention provides a separately replaceable ground ring alone or in combination with the slip ring assembly. The ground ring can be an annular ring. The ground ring can include a conductive annular body; an outer perimeter of the body; an inner perimeter of the body defining a central aperture; and at least one interface surface, disposed on the annular body, between the outer and inner perimeters, to allow for operable connection to at least one interface surface of a slip ring assembly; wherein the annular body is configured for replaceable attachment to the slip ring assembly.

The slip ring assembly of the present invention is preferably of a molded design. In other words, the slip ring assembly of the present invention is preferably not a built-up assembly, which typically is held together by several screws or other attachment devices which connect together the various components of the slip ring assembly. With a molded design, the one or more power rings and other components of the slip ring assembly, but for the replaceable ground ring, is permanently or substantially permanently affixed to the hub.

The present invention can also be useful with split power ring assemblies.

The shape of the ground ring can be any functional shape; examples include circular, elliptical, curvilinear, square, rectilinear, polygonal, contoured, undulating, toothed, spiraled, and threaded shapes. The ground ring can be in the shape of a flat annulus, a tapered ring, a torus, or any combination thereof. The inner perimeter surface and the outer perimeter surface can be substantially flat with a circular cross-section in a plane perpendicular to the axis of rotation. At least one of the outer and inner perimeters of the ground ring can be a circumference coaxial to an axis of rotation of the ground ring and the slip ring sub-assembly. The ground ring can be provided as a whole ring, ring sections, ring segments, concentric subrings, or any combination thereof.

The hub can include an interface surface complimentary in shape to an interface surface of the ground ring. The hub can optionally include a mounting ring complementary in shape to an interface surface of the ground ring. The hub, mounting ring, sub-assembly, or any combination thereof, can have a tapered design that receives the ground ring to provide a tapered fit. Interface surfaces can be continuous or discontinuous with one another. At least one of the surfaces can have a curvature with an axis perpendicular to the axis of rotation. The surface curvature can be concave, convex, or any combination thereof. The interface surfaces of the slip ring assembly, including one or more of the sub-assembly, hub, and mounting plate, can be so shaped to allow easy adjoining of a ground ring with a complementary shape. The ground ring can contain one or more sub-assembly interface surfaces. The power ring assembly interface surface can be tapered, curved, substantially flat, contoured or any suitable shape that allows connection to the slip ring assembly. The ground ring, sub-assembly, or both can include a tongue, groove, or both, on at least one surface.

The ground ring can constitute a single, or multilayered structure, or both. The conductive ground ring can include or made of any suitable conductor. The conductor can contain metallic material, non-metallic material, or both. The conductive material can contain or be at least one metal. Examples of suitable metals include copper, aluminum, tin, zinc, bronze, brass, silver, gold, platinum, palladium, tungsten, titanium, tantalum, cobalt, chromium, manganese, nickel, iron, any steel, any alloy thereof, or any combination thereof. The steel can be of any alloy. The steel can be a low carbon steel. The steel can be any stainless steel. Examples of stainless steel types include austenitic, ferritic, martensitic, and duplex stainless steels. The stainless steel can be 410 stainless steel or 416 Martensitic stainless steel. Stainless steel grades of series 200, 300, 400, 600, or any combination thereof can be employed.

The ground ring is secured to the hub, such as by way of a mounting ring on the hub, by at least one attachment device (fastener). The ground ring can have at least one attachment device operably associated with a surface that interfaces with the sub-assembly, a surface comprising the perimeter of the ground ring, a surface comprising the inner perimeter of the ground ring, or any combination thereof. The at least one attachment device can include one or more screws, bolts, pins, or any combination thereof. For any ground ring or slip ring assembly including a ground ring, one or more fasteners can be present. An attachment device can be built-in and/or structurally contiguous with the ground ring, the slip ring sub-assembly, or both. The attachment device can include at least one component that is separable from at least one of the sub-assembly, hub, mounting plate, and ground ring. The attachment device can include an adhesive. The attachment device can contain at least one magnetic material.

The ground ring, any component of the sub-assembly, or both can include at least one radial aperture in the annular body. The radial aperture can be threaded, for example, to allow entry of a screw, bolt, or both. A radial aperture can be countersunk. A slip ring assembly can be configured such that the attachment device includes threading about the inner surface or outer surface of the ground ring, the sub-assembly, or both, allowing the ground ring to be screwed to the slip ring assembly for a “jar-like” fit. The attachment device can include a brace ring clamp (external ring that may be tightened), at least one vise clamp, or both.

The ground ring, the slip ring assembly, the hub, and a mounting ring, can include at least one centering device. The attachment device can include the centering device. The centering device can include a centering pin, a centering pin aperture, an interlockable tooth array, or any combination thereof. The slip ring assembly can have an interface aid between the ground ring and slip ring assembly. For example, the interface aid can include a gasket, an o-ring, conductive paste, plating, or any combination thereof, wherein the interface aid is conductive.

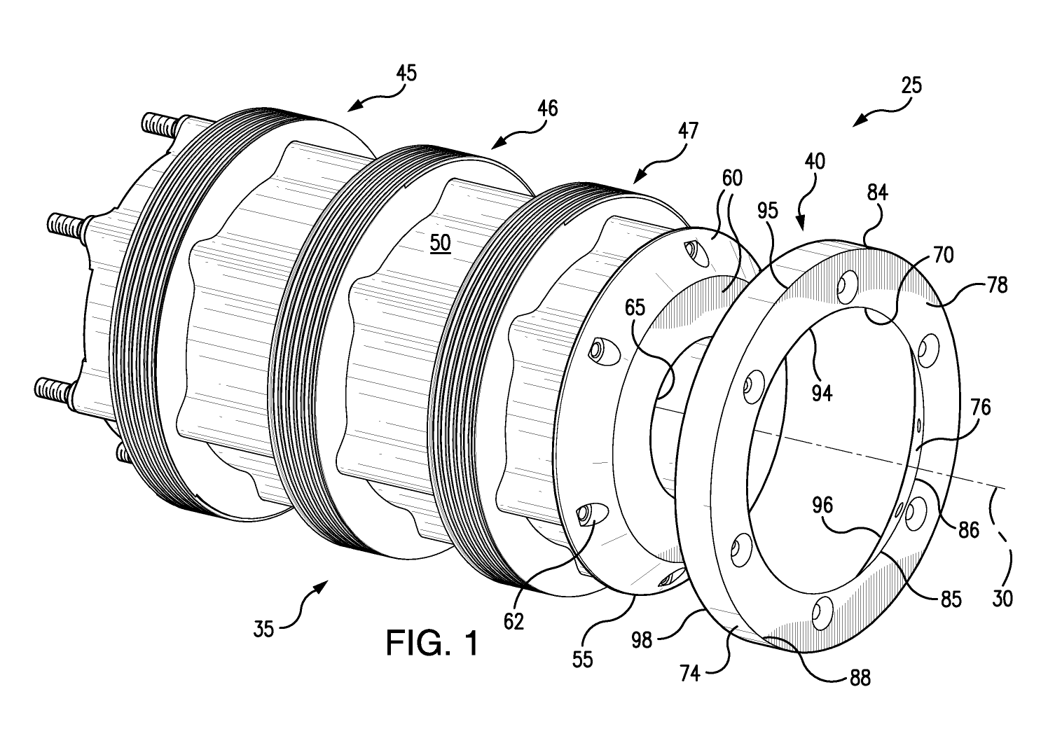

FIG. 1 shows an example of a slip ring assembly 25 of the present invention. The slip ring assembly can be positioned about a central axis or axis of rotation 30 that can be encompassed by a central armature (not shown). The slip ring assembly includes a sub-assembly 35 and a ground ring 40. The sub-assembly 35 contains at least one power ring 45. Particularly useful for three phase power generation and transfer is a configuration such as that shown in FIG. 1 including 3 power rings 45, 46, and 47. The sub-assembly also includes a hub 50. A mounting ring 55 can optionally form part of the sub-assembly. The mounting ring, or the hub itself, or any part associated with the sub-assembly, can include an interface surface 60 for operable connection to the ground ring 40. Within the sub-assembly, including the hub, there is a center aperture 65 that can allow placement of the slip ring assembly, including the sub-assembly, onto an armature, shaft, or an axle. On the interface surface can be provided radial apertures 62. Radial apertures can form part of an attachment device.

Complementing the features described above for the sub-assembly of the slip ring assembly, the ground ring can include a center aperture 70, as well as radial apertures 72. Ground ring 40 can contain a circumferential surface or other outer surface 74, which can be flat, angled, curvilinear, or any combination thereof. Ground ring 40 includes an inner surface 76 and an outer surface 78.

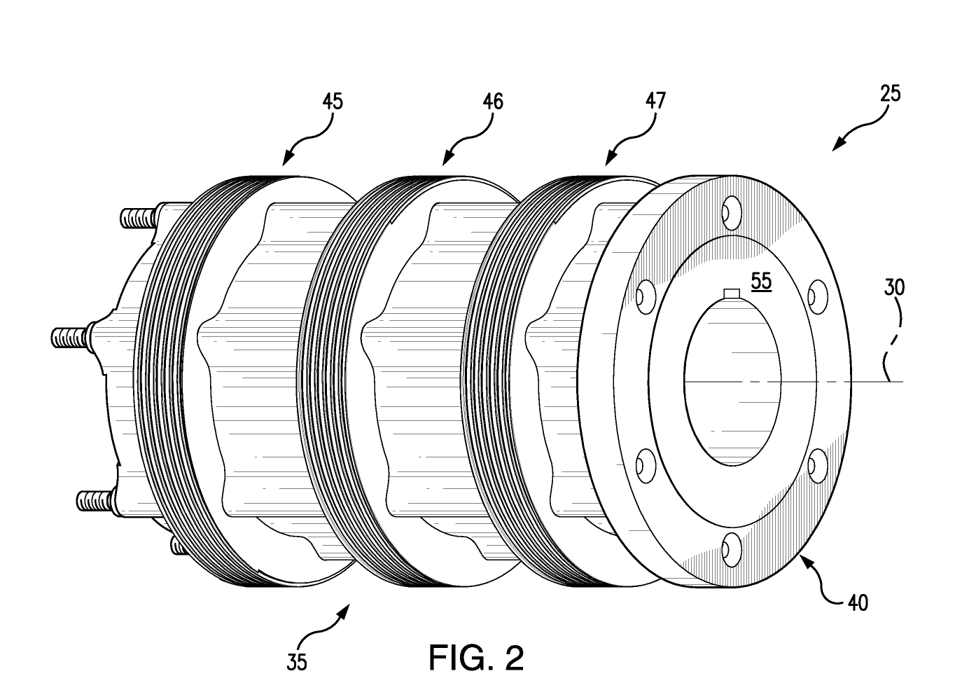

FIG. 2 shows a slip ring assembly 25 of FIG. 1 with the ground ring 40 in contact with the hub. The slip ring assembly shown in FIG. 2 shows the slip ring assembly with the ground ring in a contact position or an attached configuration with the hub or mounting ring. The ground ring is shown in contact or attached to the sub-assembly, however, it may be detached from this position to yield a configuration as shown in FIG. 1.

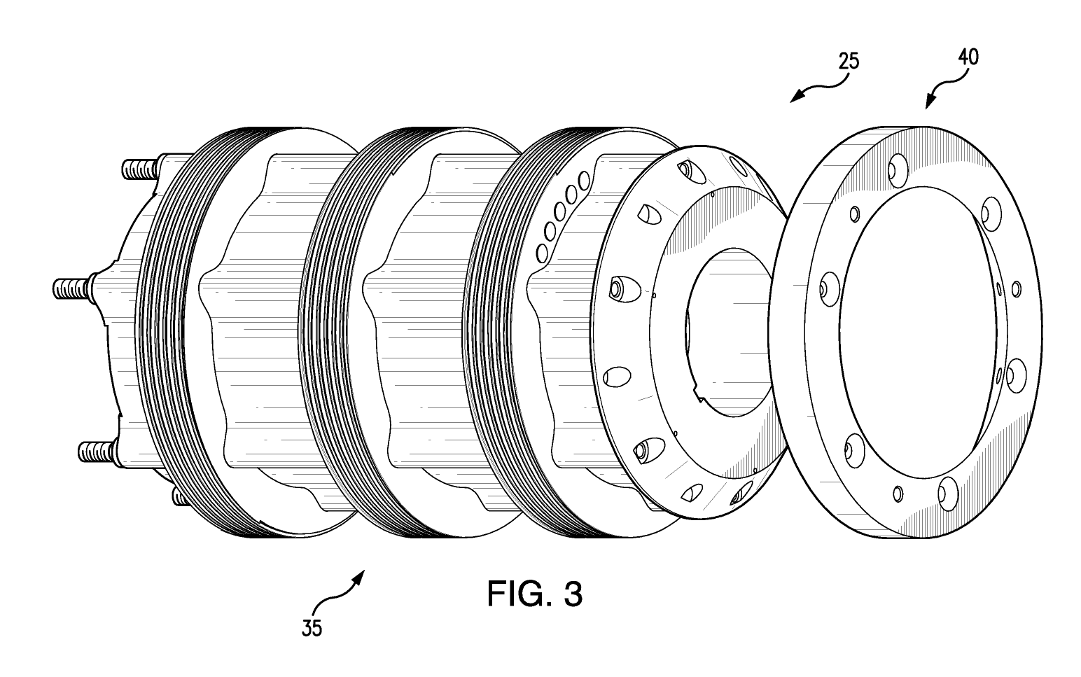

FIG. 3 shows a perspective view of the slip ring assembly 25 similar to those shown in FIGS. 2 and 3, respectively, and showing the slip ring assembly 25 with the ground ring in a detached position from the sub-assembly 35.

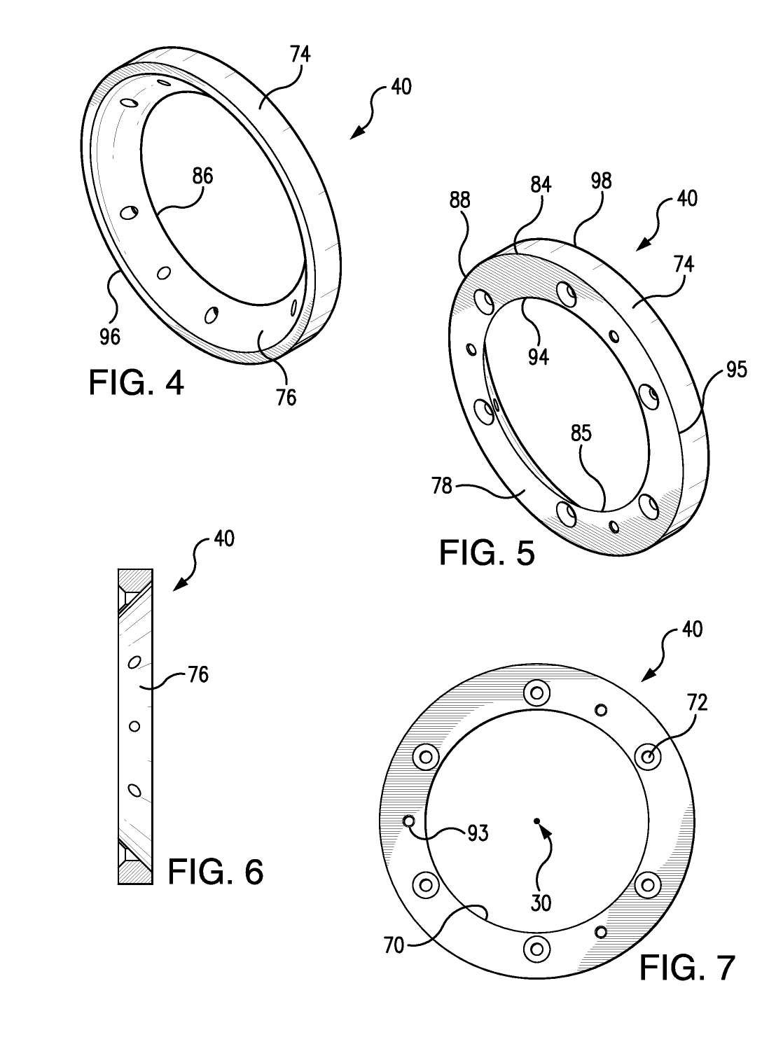

FIG. 4 shows an inner side perspective view of ground ring 40 showing circumferential outer perimeter surface 74, as well as inner surface 76. FIG. 5 shows the opposing side view from that shown in FIG. 4. FIG. 5 shows, again, outer circumferential perimeter surface 74, as well as outer side 78. FIG. 6 is a cross-sectional view of the ground ring that shows how the tapered shape is arrayed along the inner circumference inner surface 76 of ground ring 40. FIG. 7 is a cross-sectional view perpendicular to the center or axis of rotation 30 of the ground ring 40. Also shown in FIG. 7 are optional radially arrayed apertures 72, as well as the central aperture 70.

Ground ring 40 can include a central aperture 70, centered with respect to an axis of rotation 30, a perimeter surface 74, an outer surface 78, and an inner surface 76. Perimeter surface 74 can have a first end 88, a second end 98, and a circular cross-section from first end 88 to second end 98. Outer surface 78 can have an outer periphery 84 and an inner periphery 94, arranged perpendicular to the axis of rotation 30. Inner surface 76 can have a first end 86 and a second end 96. First end 86 of inner surface 76 and inner periphery 94 can intersect at a first inner edge 85. First end 88 of perimeter surface 74 and outer periphery 84 can intersect at a first outer edge 95. Inner surface 76 can taper outwardly from its first end 86 toward its second end 96. One or more mounting apertures 72 can be formed in inner surface 76 and outer surface 78 extending through ground ring 40 in a direction parallel to the axis of rotation 30 for mounting ground ring 40 to sub-assembly 35 of slip ring assembly 25.

As an option, the ground ring that is replaceable can have jack-out holes present in addition to holes used for attachment means to the hub or mounting ring. These jack-out holes permit the ability to remove the ground ring, especially if the attachment devices are difficult to remove for a variety of reasons, such as age, rust, and the like. For instance, the jack-out holes are shown as an example in FIG. 7 as 93.

The slip ring assembly of the present invention can be made by taking a starting piece of metal that will ultimately form the shape and dimensions of the hub and machining the starting piece of metal to specifications of the hub or by other means, such as by molding, cutting, and the like. Once the hub is formed to specifications, the hub can then be placed in a mold and power slip rings can be suspended around the hub, but not in contact with the hub, and then an insulating resin can be injected around the hub and in between the power slip rings and hub to form the molded slip ring assembly. This technique is known as transfer molding and is conventionally used to make certain types of slip ring assemblies and other devices. The replaceable ground ring can be formed by taking a starting piece of metal and machining to specifications as described herein such that it can be attached to the hub or mounting ring on the hub and yet be detachable from the remaining slip ring assembly or hub.

The present invention provides a method of replacing a worn or damaged ground ring of a slip ring assembly. The method can include removing an existing ground ring from a slip ring assembly comprising a hub, at least one ground ring, and at least one power ring; and attaching a replacement ground ring of the present invention to the slip ring assembly. The slip ring assembly, including the sub-assembly, can be left in place, for example, on a central armature, during at least one of the removing and attaching steps. For a reversible ground ring, one containing two opposite sides either of which can contact the sub-assembly, a method of replacement can include flipping the ground ring around so that the non-worn side of the ground ring contacts the sub-assembly and the worn side faces away from the sub-assembly.

The present invention also provides kits. A kit can include a ground ring of the present invention and any other suitable components such as attachment devices and one or more tools for detaching an old ground ring and installing a new ground ring. The kits can be used in conjunction with the slip ring assemblies and methods of the invention.

The slip ring assemblies, and components thereof, can be used in combination with any related or compatible power or electrical device. The power or electrical device can be a generator. The generator can be a generator for use in a wind turbine, steam turbine, hydroelectric turbine, or any combination thereof. Any suitable generator can be used. The generator can be of any power generating capacity. Such a generator can have greater than about 1 kilowatt, greater than about 1 megawatt, greater than about 1 gigawatt, greater than about 1 terawatt, or greater than about 1 petawatt. For example, a 1.5 MW generator available from Hitachi Power Systems America, Ltd. of Basking Ridge, N.J., can be employed.

The present invention includes the following aspects/embodiments/features in any order and/or in any combination:

1. The present invention relates to a slip ring assembly comprising a separately replaceable ground ring, the ground ring comprising:
a central aperture centered with respect to an axis of rotation; a perimeter surface having a first end, a second end, and a circular cross-section from the first end to the second end;
an outer surface having an outer periphery and an inner periphery arranged perpendicularly to the axis of rotation; and
an inner surface having a first end and a second end, wherein the first end of the inner wall and the inner periphery intersect at a first inner edge, the first end of the perimeter surface and the outer periphery intersect at a first outer edge, the inner surface tapers outwardly from its first end toward its second end, and one or more mounting apertures are formed in the inner surface and outer surface extending through the ground ring in a direction parallel to the axis of rotation for mounting the ground ring to the slip ring assembly.

2. A slip ring assembly comprising:
at least one power ring affixed to a hub and at least one ground ring mounted on the hub, wherein the ground ring is separately replaceable, while the slip ring assembly is in cooperation with an armature and without having to replace the power ring or hub or both.

3. The slip ring assembly of any preceding or following embodiment/feature/aspect, wherein the at least one power ring and hub of the slip ring assembly comprise a molded sub-assembly.

4. The slip ring assembly of any preceding or following embodiment/feature/aspect, wherein the molded sub-assembly is shrink-fit.

5. The slip ring assembly of any preceding or following embodiment/feature/aspect, wherein the ground ring comprises an annular ring.

6. The slip ring assembly of any preceding or following embodiment/feature/aspect, wherein the hub comprises an interface surface complimentary in shape to an interface surface of the ground ring.

7. The slip ring assembly of any preceding or following embodiment/feature/aspect, wherein the hub comprises a mounting ring complementary in shape to an interface surface of the ground ring.

8. The slip ring assembly of any preceding or following embodiment/feature/aspect, wherein the hub has a tapered design that receives the ground ring to provide a tapered fit.

9. The slip ring assembly of any preceding or following embodiment/feature/aspect, wherein the ground ring is secured to the hub by at least one attachment device.

10. The slip ring assembly of any preceding or following embodiment/feature/aspect, wherein the at least one attachment device comprises one or more screws, bolts, pins, or any combination thereof.

11. The slip ring assembly of any preceding or following embodiment/feature/aspect, wherein at least one of the ground ring, the slip ring assembly, the hub, and a mounting ring comprises at least one centering device.

12. The slip ring assembly of any preceding or following embodiment/feature/aspect, wherein an attachment device comprises the centering device.

13. The slip ring assembly of any preceding or following embodiment/feature/aspect, wherein the centering device comprises a centering pin, a centering pin aperture, an interlockable tooth array, or any combination thereof.

14. The slip ring assembly of any preceding or following embodiment/feature/aspect, wherein the assembly further comprises an interface aid between the ground ring and slip ring assembly.

15. The slip ring assembly of any preceding or following embodiment/feature/aspect, wherein the interface aid comprises a gasket, conductive paste, plating, an o-ring, or any combination thereof.

16. The slip ring assembly of any preceding or following embodiment/feature/aspect, wherein the slip ring assembly comprises three power rings.

17. The slip ring assembly of any preceding or following embodiment/feature/aspect, wherein the assembly further comprises at least one brush in electromechanical association with the at least one power ring.

18. A method of replacing a worn or damaged ground ring of a slip ring assembly, the method comprising:
removing an existing ground ring from a slip ring assembly comprising a hub, at least one ground ring, and at least one power ring; and
attaching a replacement ground ring to the slip ring assembly.

19. The method of any preceding or following embodiment/feature/aspect, wherein the slip ring assembly is left attached to an armature during the removing and attaching steps.

20. A ground ring configured to be separately replaceable in a slip ring assembly, the ground ring comprising:
a conductive annular body; an outer perimeter of the body; an inner perimeter of the body defining a central aperture; and at least one interface surface, disposed on the annular body, between the outer and inner perimeters, to allow for operable connection to at least one interface surface of a slip ring assembly;
wherein the annular body is configured for replaceable attachment to the slip ring assembly.

21. The ground ring of any preceding or following embodiment/feature/aspect, wherein the slip ring assembly interface surface and the ground ring interface surface are complementarily tapered.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A slip ring assembly comprising a separately replaceable ground ring, the ground ring comprising:
a central aperture centered with respect to an axis of rotation;
a perimeter surface having a first end, a second end, and a circular cross-section from the first end to the second end;
an outer surface having an outer periphery and an inner periphery arranged perpendicularly to the axis of rotation; and
an inner surface having a first end and a second end, wherein the first end of the inner wall and the inner periphery intersect at a first inner edge, the first end of the perimeter surface and the outer periphery intersect at a first outer edge, the inner surface tapers outwardly from its first end toward its second end, and one or more mounting apertures are formed in the inner surface and outer surface extending through the ground ring in a direction parallel to the axis of rotation for mounting the ground ring to the slip ring assembly.

2. A slip ring assembly comprising:
at least one power ring affixed to a hub and at least one ground ring mounted on the hub, wherein the ground ring is separately replaceable, while the slip ring assembly is in cooperation with an armature and without having to replace the power ring or hub or both.

3. The slip ring assembly of claim 2, wherein the at least one power ring and hub of the slip ring assembly comprise a molded sub-assembly.

4. The slip ring assembly of claim 3, wherein the molded sub-assembly is shrink-fit.

5. The slip ring assembly of claim 2, wherein the ground ring comprises an annular ring.

6. The slip ring assembly of claim 2, wherein the hub comprises an interface surface complimentary in shape to an interface surface of the ground ring.

7. The slip ring assembly of claim 2, wherein the hub comprises a mounting ring complementary in shape to an interface surface of the ground ring.

8. The slip ring assembly of claim 2, wherein the hub has a tapered design that receives the ground ring to provide a tapered fit.

9. The slip ring assembly of claim 2, wherein the ground ring is secured to the hub by at least one attachment device.

10. The slip ring assembly of claim 9, wherein the at least one attachment device comprises one or more screws, bolts, pins, or any combination thereof.

11. The slip ring assembly of claim 2, wherein at least one of the ground ring, the slip ring assembly, the hub, and a mounting ring comprises at least one centering device.

12. The slip ring assembly of claim 11, wherein an attachment device comprises the centering device.

13. The slip ring assembly of claim 11, wherein the centering device comprises a centering pin, a centering pin aperture, an interlockable tooth array, or any combination thereof.

14. The slip ring assembly of claim 2, wherein the assembly further comprises an interface aid between the ground ring and slip ring assembly.

15. The slip ring assembly of claim 14, wherein the interface aid comprises a gasket, conductive paste, plating, an o-ring, or any combination thereof.

16. The slip ring assembly of claim 2, wherein the slip ring assembly comprises three power rings.

17. The slip ring assembly of claim 2, wherein the assembly further comprises at least one brush in electromechanical association with the at least one power ring.

18. A method of replacing a worn or damaged ground ring of a slip ring assembly, the method comprising:
removing an existing ground ring from a slip ring assembly comprising a hub, at least one ground ring, and at least one power ring; and
attaching a replacement ground ring to the slip ring assembly.

19. The method of claim 18, wherein the slip ring assembly is left attached to an armature during the removing and attaching steps.

20. A ground ring configured to be separately replaceable in a slip ring assembly, the ground ring comprising:
a conductive annular body; an outer perimeter of the body; an inner perimeter of the body defining a central aperture; and at least one interface surface, disposed on the annular body, between the outer and inner perimeters, to allow for operable connection to at least one interface surface of a slip ring assembly;
wherein the annular body is configured for replaceable attachment to the slip ring assembly.

21. The ground ring of claim 20, wherein the slip ring assembly interface surface and the ground ring interface surface are complementarily tapered.
